(19) United States
(12) Patent Application Publication
(10) Pub. No.: US 2022/0407056 A1
(43) Pub. Date: Dec. 22, 2022

(54) CATHODE, ELECTROCHEMICAL BATTERY INCLUDING THE SAME, AND METHOD OF MANUFACTURING THE SAME

(71) Applicants: Samsung Electronics Co., Ltd., Suwon-si (KR); Industry-University Cooperation Foundation Hanyang University ERICA Campus, Ansan-si (KR)

(72) Inventors: Joungwon Park, Seongnam-si (KR); Kyumoon Kwon, Ansan-si (KR); Kyounghwan Kim, Seoul (KR); Taejoo Park, Ansan-si (KR); Hwiyeol Park, Hwaseong-si (KR); Huisu Jeong, Seongnam-si (KR)

(21) Appl. No.: 17/751,893

(22) Filed: May 24, 2022

(30) Foreign Application Priority Data
Jun. 14, 2021 (KR) 10-2021-0076990

(51) Int. Cl. H01M 4/36; H01M 4/04; H01M 4/62; H01M 10/0525

(52) U.S. Cl. CPC H01M 4/366; H01M 4/0428; H01M 4/626; H01M 10/0525

(57) ABSTRACT

A cathode includes: a cathode current collector; a cathode active material layer on the cathode current collector and including a first surface, and a second surface opposite the first surface and adjacent to the cathode current collector, wherein the cathode active material layer includes a channel structure including a channel extending in a direction from the first surface to the second surface; and a conductive metal layer disposed on a surface of the channel of the channel structure.

### CROSS-REFERENCE TO RELATED APPLICATION

This application is based on and claims priority to Korean Patent Application No. 10-2021-0076990, filed on Jun. 14, 2021, in the Korean Intellectual Property Office, and all the benefits accruing therefrom under 35 U.S.C. § 119, the content of which in its entirety is herein incorporated by reference.

### BACKGROUND

### 1. Field

The present disclosure relates to a cathode, an electrochemical battery including the same, and methods of manufacturing the cathode.

### 2. Description of the Related Art

With the advancement of technology in the electronics field, markets for various types of mobile electronic appliances such as mobile phones, game consoles, portable multimedia players (“PMPs”), and mpeg audio layer-3 (“MP3”) players as well as smartphones, smart pads, e-readers, tablet computers, and mobile medical devices attached to the body, are growing significantly. As mobile electronic appliance-related markets grow, the demand for batteries suitable for driving mobile electronic appliance is also increasing.

A secondary battery is a battery capable of being charged and discharged, unlike a primary battery that cannot be charged. In particular, a lithium secondary battery has advantages of having a higher voltage than a nickel-cadmium battery or a nickel-hydrogen battery, and also having a greater specific energy than the nickel-cadmium battery or the nickel-hydrogen battery.

There remains a need for improved battery materials.

### SUMMARY

Provided is a cathode having improved conductivity.

Provided is an electrochemical battery having improved lifespan characteristics.

Provided is a method of manufacturing a cathode having improved conductivity.

Additional aspects will be set forth in part in the description which follows and, in part, will be apparent from the description, or may be learned by practice of the presented embodiments of the disclosure.

According to an aspect of an embodiment, a cathode includes: a cathode current collector; a cathode active material layer on the cathode current collector and including a first surface, and a second surface opposite the first surface and adjacent to the cathode current collector, wherein the cathode active material layer includes a channel structure including a channel extending in a direction from the first surface to the second surface; and includes a conductive metal layer disposed on a surface of the channel of the channel structure.

According to an aspect of another embodiment, an electrochemical battery includes: the cathode; an anode; a separator between the cathode and the anode; and a liquid electrolyte in a pore of the separator.

According to an aspect of another embodiment, a method of manufacturing a cathode includes: providing a cathode active material layer including a first surface and a second surface opposite the first surface and including a channel structure extending in a direction from the first surface to the second surface; and disposing a conductive metal layer on a surface of a channel of the channel structure to manufacture the cathode.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view schematically illustrating an embodiment of a structure of a cathode;

FIG. 2 is a partial cross-sectional view partially showing the inside of the cathode of FIG. 1;

FIG. 3 is a cross-sectional view of the cathode of FIG. 2 taken along the line A-A in FIG. 2;

FIG. 4 is a cross-sectional view of an embodiment of a cathode;

FIG. 5 is a perspective view of an embodiment including a plurality of cathode active material layer structures;

FIG. 6 is an exploded perspective view of the plurality of cathode active material layer structures shown in FIG. 5;

FIG. 7 is a cross-sectional view of the plurality of cathode material layer structures of FIG. 5 taken along line A-A in FIG. 5;

FIG. 8 is a cross-sectional view of an embodiment including a plurality of cathode active material layer structures;

FIG. 9 is a cross-sectional view of an embodiment including a plurality of cathode active material layer structures;

FIG. 10 is a cross-sectional view of an embodiment including a plurality of cathode active material layer structures;

FIG. 11 is a perspective view an embodiment schematically illustrating a structure of an electrochemical battery 100;

FIG. 12 is a partial perspective cross-sectional view partially illustrating the inside of the electrochemical battery 100 of FIG. 11;

FIG. 13 is a cross-sectional view of the electrochemical battery 100 of FIG. 12 taken along line A-A in FIG. 12;

FIGS. 14A to 14E are perspective views for explaining a method of manufacturing a cathode;

FIG. 15 is a graph of imaginary impedance (Z″, ohms-square centimeters, Ω·cm²) vs. real impedance (Z′, Ω·cm²) and is a Nyquist plot showing the results of impedance analysis of half-cells including the cathodes of Example 1 and Comparative Example 1;

FIG. 16 is a graph of intensity (arbitrary units, a.u.) vs. binding energy (electron volts, eV) and shows the results of X-ray photoelectron spectroscopy (XPS) analysis of the surface of the cathode manufactured in Example 1;

FIGS. 17A and 17B are each a graph of intensity (a.u.) vs. binding energy (eV) and show the results of XPS analysis of the surface of the cathode at three different times;

FIG. 18 is a graph of capacity (milliampere-hours per gram, mAh/g) vs. cycles (number) illustrating the lifespan characteristics of the lithium batteries manufactured in Example 1 and Comparative Example 1;

FIG. 19A is a graph of voltage (volts, V) vs. time (seconds, s) and shows a charging profile of the lithium batteries manufactured in Example 1 and Comparative Example 1 in the 280^{th} charging cycle; and

FIG. 19B shows charging time (percent, %) and charging profile of the lithium batteries manufactured in Example 1 and Comparative Example 1 in the 280^{th} charging cycle.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. Expressions such as “at least one of,” when preceding a list of elements, modify the entire list of elements and do not modify the individual elements of the list.

Hereinafter, cathodes according to embodiments, electrochemical batteries including the same, and methods of manufacturing the cathodes will be described in more detail with reference to the accompanying drawings.

In the following drawings, the same reference numerals refer to the same components, and the size or thickness of each component in the drawings may be exaggerated for clarity and convenience of description. In addition, embodiments to be described below are merely exemplary, and various modifications are possible from these embodiments. In the disclosure of the layer structure, “upper” or “on” may include not only directly in contact, but also above in a non-contact manner. In contrast, when an element is referred to as being “directly on” another element, there are no intervening elements present.

It will be understood that, although the terms “first,” “second,” “third,” etc. may be used herein to describe various elements, components, regions, layers and/or sections, these elements, components, regions, layers, and/or sections should not be limited by these terms. These terms are only used to distinguish one element, component, region, layer or section from another element, component, region, layer or section. Thus, “a first element,” “component,” “region,” “layer,” or “section” discussed below could be termed a second element, component, region, layer, or section without departing from the teachings herein.

The terminology used herein is for the purpose of describing particular embodiments only and is not intended to be limiting. Singular expressions include plural expressions unless the context clearly indicates otherwise. Also, when a part “includes” a certain component, it means that other components may be further included, rather than excluding other components, unless otherwise stated. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

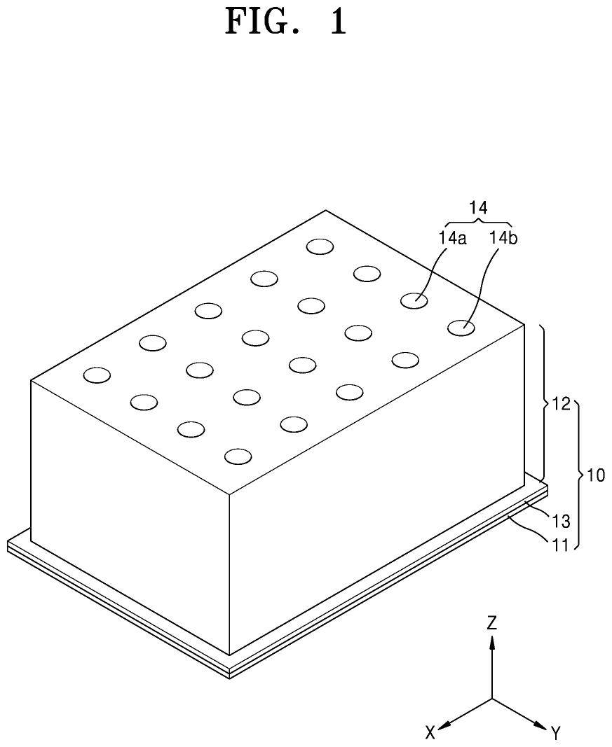

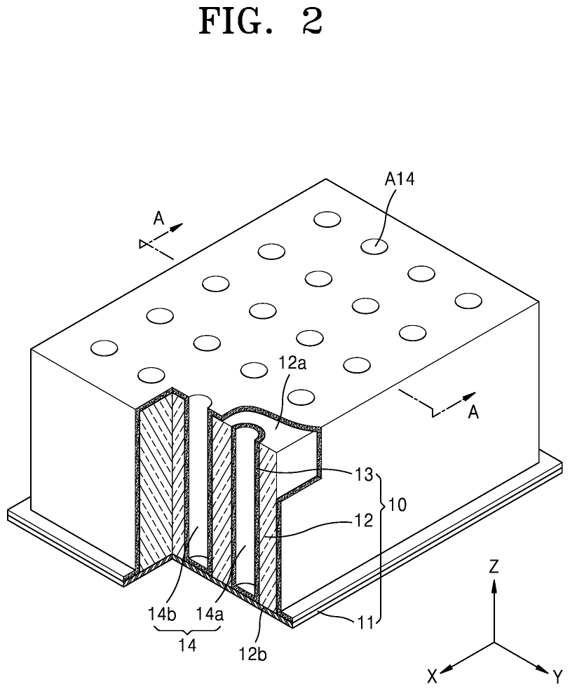

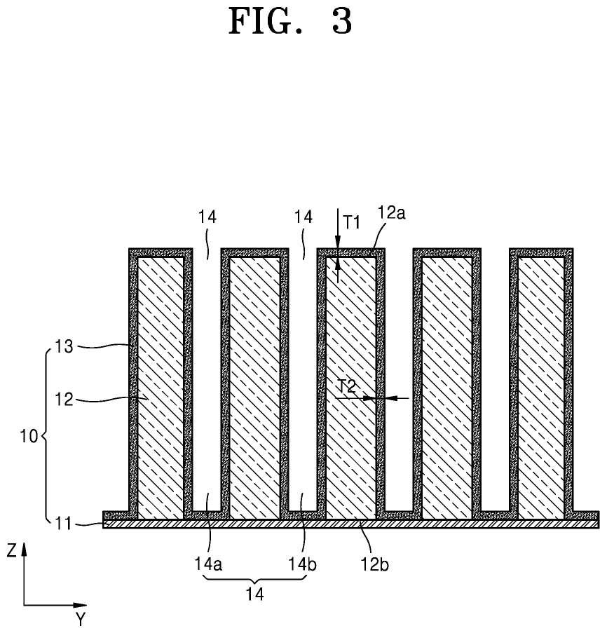

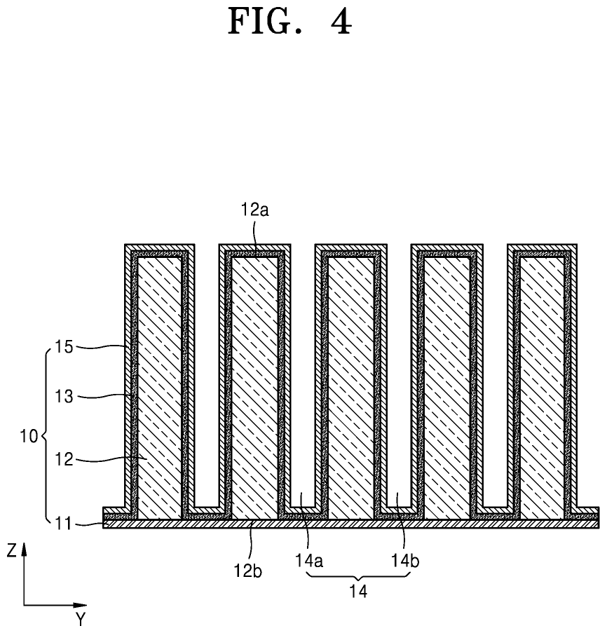

FIG. 1 is a perspective view schematically illustrating a structure of a cathode according to an embodiment. FIG. 2 is a partial cross-sectional view partially showing the inside of the cathode of FIG. 1. FIG. 3 is a cross-sectional view of the cathode of FIG. 2 taken along line A-A in FIG. 2. FIG. 4 is a cross-sectional view of a cathode according to another embodiment.

Referring to FIGS. 1 to 3, a cathode 10 according to an embodiment includes: a cathode current collector 11; and a cathode active material layer 12 on the cathode current collector 11 and including a first surface 12a and a second surface 12b opposite the first surface 12a and adjacent to the cathode current collector 11, wherein the cathode active material layer 12 has a channel structure 14 comprising a channel extending in a direction from the first surface 12a to the second surface 12b, and includes a conductive metal layer 13 disposed on the inner surfaces of one or more channels 14a and 14b of the channel structure 14.

In a cathode in the art, and while not wanting to be bound by theory, it is understood that non-uniform current distribution occurs due to cracks and surface defects of grain boundaries exposed on the surface of a cathode active material layer during charge and discharge. Accordingly, on the surface of the cathode active material layer, localized over-lithiation is understood to occur, and side reactions with an electrolyte are understood to increase. As a result, deterioration of the cathode is promoted.

In contrast, in the cathode 10 according to an embodiment, the conductive metal layer 13 is provided on the surfaces of the channels 14a and 14b, so that it is possible to effectively prevent non-uniform current distribution due to cracks and surface defects of the grain boundaries exposed on the surface of the positive electrode active material layer 12, particularly, on the side surface thereof. In an aspect, the side surfaces of the one or more channels 14a and 14b corresponds to an inner surfaces or interior surface of the cathode active material layer 12. In addition, in the channel structure 14, electrons may more easily move in the conductive metal layer 13, so that localized over-lithiation on the surface of the cathode active material layer 12, particularly, on the side surface thereof, is suppressed, and side reactions with the electrolyte are also suppressed. As a result, reversibility of cathode reactions is improved, and deterioration of the cathode 10 is suppressed. In addition, the cathode active material layer 12 has the channel structure 14, so that lithium ions may be easily conducted to the inside of the cathode active material layer 12. Accordingly, cycle characteristics such as high-rate characteristics and lifespan characteristics of a battery including the cathode 10 may be improved.

Referring to FIGS. 1 to 3, the cathode active material layer 12 having the channel structure 14 has a three-dimensional structure. In the electrochemical battery including the cathode active material layer 12 having a three-dimensional structure, capacity and energy density are significantly improved compared to an electrochemical battery including a cathode active material layer having a two-dimensional structure (that is, a planar structure). The three-dimensional cathode active material layer 12 may provide an increased cathode active material volume fraction and a large reaction area compared to a planar cathode active material layer. Accordingly, the three-dimensional cathode active material layer 12 may be advantageous to improve energy density and high-rate characteristics of an electrochemical battery.

The thickness of the conductive metal layer 13 is, for example, about 1 nanometer (nm) to about 50 nm, about 1 nm to about 30 nm, or about 1 nm to about 20 nm. When the conductive metal layer 13 has a thickness within this range, ion conductivity through the conductive metal layer 13 may be obtained. In an aspect, ion conductivity through the conductive metal layer 13 may be about 1.0×10⁻⁴ Siemens per centimeter (S/cm) to about 1.0×10¹ S/cm, or about 2.0×10⁻⁴ S/cm to about 5.0 S/cm. Ion conductivity may be determined by a complex impedance method at 20° C., further details of which can be found in J.-M. Winand et al., “Measurement of Ionic Conductivity in Solid Electrolytes,” Europhysics Letters, vol. 8, no. 5, p. 447-452, 1989. When the thickness of the conductive metal layer 13 excessively increases, ion resistance excessively increases. Accordingly, the reversibility of a cathode reaction may be deteriorated, and as a result, the cycle characteristics of a battery including the cathode 10 may be deteriorated. When the conductive metal layer 13 is too thin, it may be difficult to provide an effect caused by the addition of the conductive metal layer 13.

The conductive metal layer 13 may be on the first surface 12a of the cathode active material layer 12. Also, the channel may comprise one or more channels, e.g., channels 14a and 14b, and the conductive metal layer may be on a surface of the one or more channels 14a and 14b that extend from the first surface 12a of the cathode active material layer 12 to the second surface of the cathode active material layer 12b. In an aspect, the surfaces of the one or more channels 14a and 14b corresponds to an inner surfaces of the cathode active material layer 12. The conductive metal layer 13 may cover some or all of the surfaces of the one or more channels 14a and 14b. The conductive metal layer 13 may cover a portion of, or all of, the first surface 12a of the cathode active material layer 12.

The area of the conductive metal layer 13 on the first surface of the cathode active material layer is, for example, about 1 percent (%) to about 99%, about 1% to about 90%, about 1% to about 80%, or about 1% to about 70%, based on a total area of the surface of the one or more channels 14a and 14b. As the area of the conductive metal layer 13 increases, side reactions between the electrolyte and the surfaces of the channels 14a and 14b, may be more effectively suppressed.

The area of the conductive metal layer 13 on the first surface of the cathode active material layer is, for example, about 1 percent (%) to about 99%, about 1% to about 90%, about 1% to about 80%, or about 1% to about 70%, based on the total area of the first surface 12a of the cathode active material layer 12. As the area of the conductive metal layer 13 increases, side reactions between the first surface 12a of the cathode active material layer 12 and the electrolyte may be more effectively suppressed.

A ratio (T2/T1) of the thickness T2 of the conductive metal layer 13 on the surfaces of the channels 14a and 14b to the thickness T1 of the conductive metal layer 13 on the first surface 12a of the cathode active material layer 12 is, for example, about 0.3 to about 1.5, about 0.5 to about 1.2, or about 0.7 to about 1. When the conductive metal layer 13 has a thickness of less than about 50 nm, the thickness ratio (T2/T1) thereof may have a high value of about 0.3 or greater. That is, the conductive metal layer 13 may be uniformly disposed on the first surface 12a of the cathode active material layer 12 and the surfaces of the channels 14a and 14b. The conductive metal layer 13 may be a conformal coating layer formed to match the surface contour of the cathode active material layer 12.

The metal included in the conductive metal layer 13 may have excellent mechanical properties. Since the conductive metal layer 13 has excellent mechanical properties, conductive metal layer 13 may more easily accommodate a change in the volume of the cathode 10 during charge and discharge, and may not be easily separated from the cathode active material layer 12.

The conductive metal layer 13 may include, for example, ruthenium (Ru), aluminum (Al), gold (Au), platinum (Pt), nickel (Ni), indium (In), copper (Cu), magnesium (Mg), stainless steel, titanium (Ti), iron (Fe), zinc (Zn), germanium (Ge), an alloy thereof, or a combination thereof. The conductive metal layer 13 may include, for example, ruthenium (Ru), aluminum (Al), gold (Au), platinum (Pt), or nickel (Ni).

The channel structure 14 of the positive electrode active material layer 12 may include, for example, a through-hole extending from the first surface 12a to the second surface 12b of the cathode active material layer 12. Accordingly, one or more channels 14a and 14b of the channel structure are, for example, through-holes. Since the channel structure 14 includes the through-hole, lithium ions may be more easily conducted to the inside of the cathode active material layer 12 adjacent to the cathode current collector 11. As a result, the non-uniformity of current distribution between the region adjacent to the first surface 12a of the cathode active material layer 12 and the region adjacent to the second surface 12b of the cathode active material layer 12 may be suppressed.

A cross-sectional area A14 of the one or more channels 14a and 14b is, for example, about 1% to about 15%, about 1% to about 10%, or about 1% to about 5%, based on the total area of the first surface 12a of the cathode active material layer 12. When the cross-sectional area A14 of the one or more channels 14a and 14b excessively increases, the energy density of the battery decreases. When the cross-sectional area A14 of the one or more channels 14a and 14b excessively decreases, it may be difficult to express the effect caused by the introduction of the channels.

A diameter (D) of each of the one or more channels 14a and 14b included in the cathode active material layer 12 is, for example, about 10 micrometer (μm) to about 300 μm, about 10 μm to about 200 μm, or about 10 μm to about 100 μm. When the channel has a diameter within this range, the cycle characteristics of the battery including the cathode may be further improved.

A distance, e.g., a pitch P1 between the plurality of channels 14a and 14b, which are spaced apart from each other, included in the cathode active material layer 12 is, for example, about 50 μm to about 1000 μm, about 100 μm to about 1000 μm, about 200 μm to about 700 μm, or about 300 μm to about 500 μm. When the distance between the plurality of channels is within the above range, the cycle characteristics of the battery including the cathode may be further improved.

Referring to FIG. 4, in the cathode 10, a metal oxide layer 14 may be additionally disposed on the conductive metal layer 13. For example, a conductive metal layer 13 is disposed on the surfaces of one or more channels 14a and 14b of the channel structure 14, and a metal oxide layer 14 is disposed on the surface of the conductive metal layer 13. Since both the conductive metal layer 13 and the metal oxide layer 14 are disposed on the surfaces of the channels 14a and 14b, side reactions between the cathode active material layer 12 and the electrolyte may be more effectively suppressed.

The area of the metal oxide layer 14 on the first surface of the cathode active material layer is, for example, about 1% to about 100%, about 1% to about 99%, about 1% to about 90%, about 1% to about 80%, or about 1% to about 70%, based on the total area of the conductive metal layer 13 on the first surface 12a of the cathode active material layer 12. As the area of the metal oxide layer 14 increases, side reactions between the first surface 12a of the cathode active material layer 12 and the electrolyte may be more effectively suppressed.

The metal oxide layer may comprise an oxide of a metal of ruthenium (Ru), aluminum (Al), gold (Au), platinum (Pt), nickel (Ni), indium (In), copper (Cu), magnesium (Mg), stainless steel, titanium (Ti), iron (Fe), zinc (Zn), germanium (Ge), an alloy thereof, or a combination thereof. For example, the metal oxide layer 14 may include a metal oxide of RuO₂, Al₂O₃, Au₂O₃, PtO₂, NiO, In₂O₃, CuO, MgO, TiO₂, Fe₂O₃, ZnO, GeO₂, or a combination thereof.

Although not shown in the drawings, the anode 10 may further include a deposition layer on the conductive metal layer 13 and/or the metal oxide layer 14. The deposition layer (e.g., plated layer) may be deposited or plated on the conductive metal layer 13 and/or the metal oxide layer 14 through a decomposition reaction of the electrolyte during the charge/discharge process of the battery having the cathode. The deposition layer may be an electrolyte layer having ion conductivity. The deposition layer may be, for example, a solid electrolyte layer. The deposition layer is, for example, a solid electrolyte interphase (SEI) layer, and the SEI may be a ion conductive reaction product of the electrolyte on a surface of the anode.

Referring to FIGS. 1 to 4, the density of the cathode active material layer 12 included in the cathode 10 is about 4.0 grams per cubic centimeter (g/cc) to about 4.9 g/cc, about 4.2 g/cc to about 4.8 g/cc, or 4.3 g/cc to about 4.7 g/cc. The density of the cathode active material layer 12 is the density of a region excluding the channel structure 14. When the cathode active material layer 12 is, for example, a sintered product, it has a high density. Since the cathode active material layer 12 has such a high density, it is possible to provide an increased energy density compared to a conventional battery.

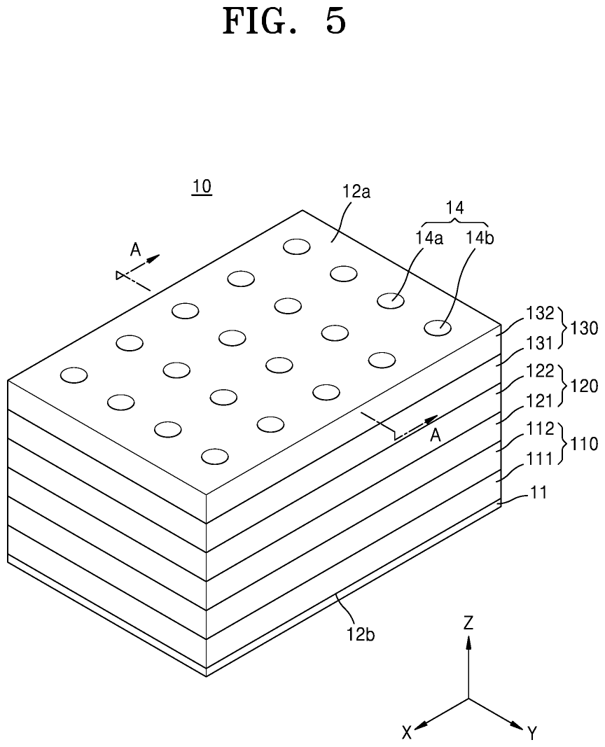

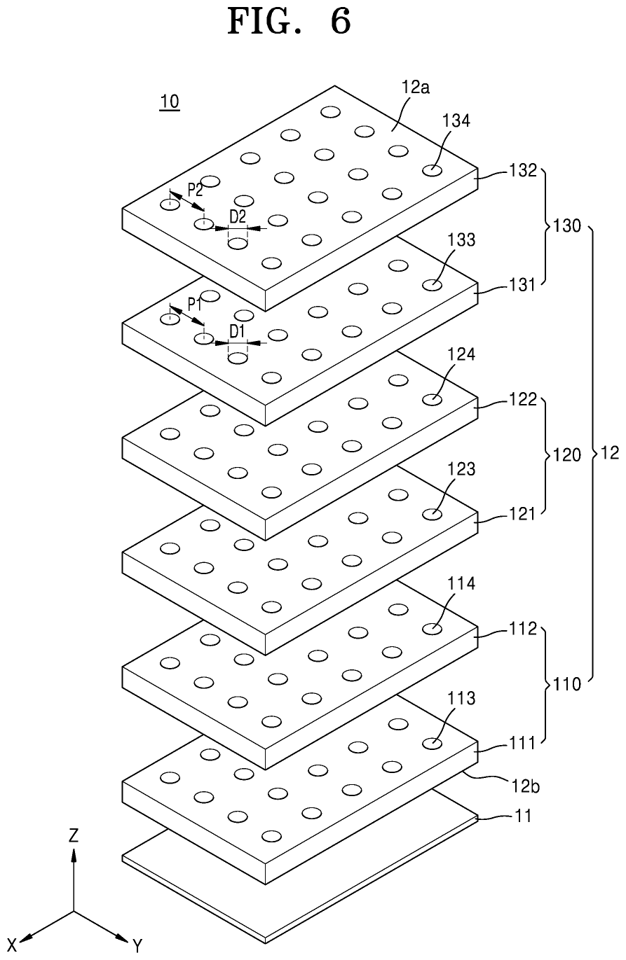

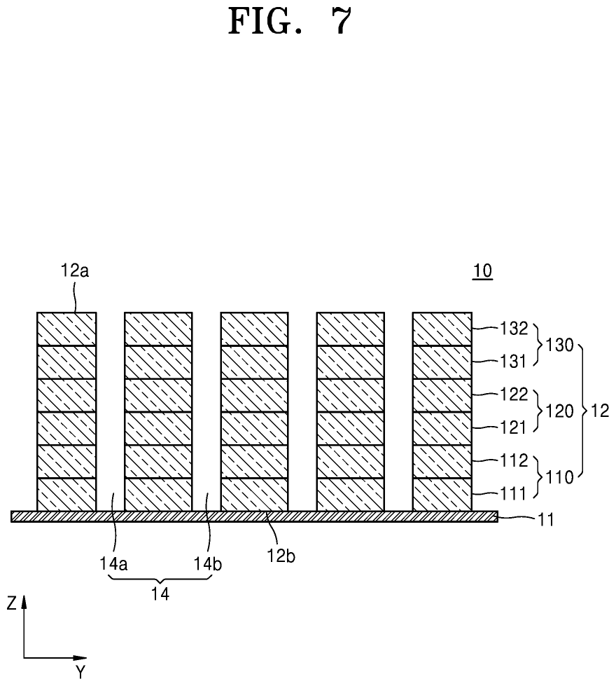

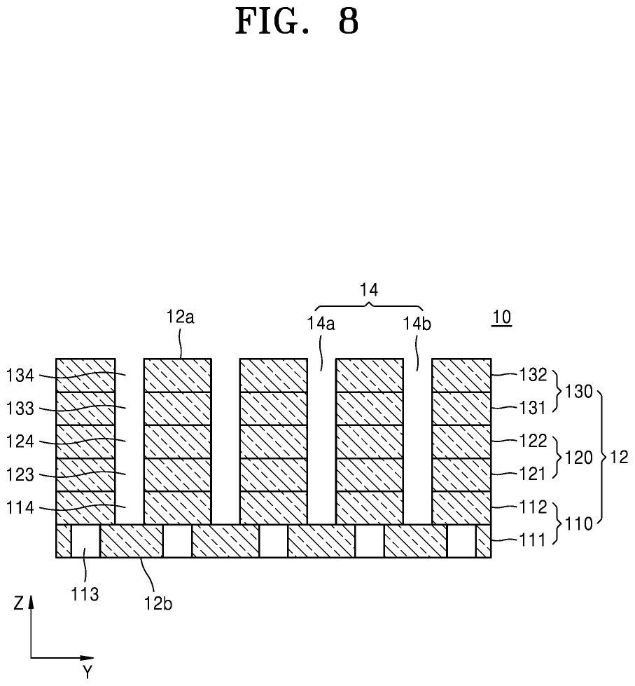

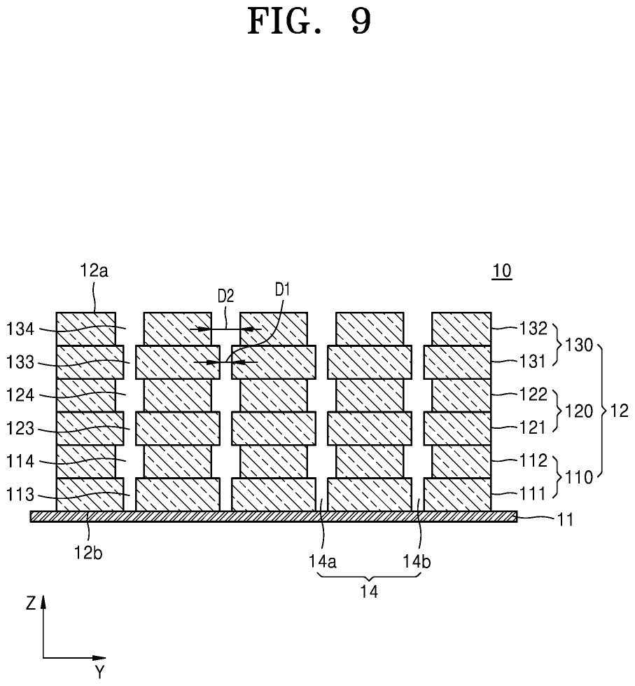

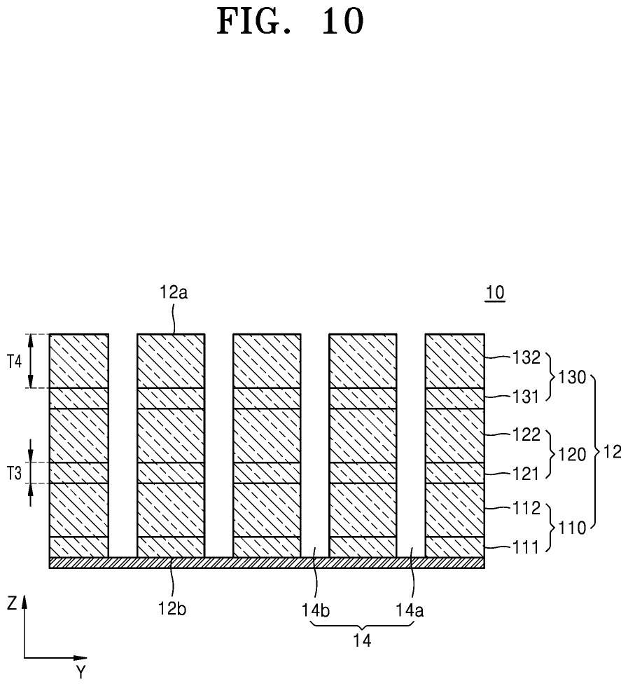

FIG. 5 is a perspective view of a plurality of cathode active material layer structures according to an example. FIG. 6 is an exploded perspective view of the plurality of cathode active material layer structures shown in FIG. 5. FIG. 7 is a cross-sectional view of the plurality of cathode material layer structures of FIG. 5 taken along line A-A in FIG. 5. FIG. 8 is a cross-sectional view of a plurality of cathode active material layer structures according to an embodiment. FIG. 9 is a cross-sectional view of a plurality of cathode active material layer structures according to another embodiment. FIG. 10 is a cross-sectional view of a plurality of cathode active material layer structures according to another embodiment.

Referring to FIGS. 5 to 8, the cathode 10 includes a cathode current collector 11 and a cathode active material layer 12 on the cathode current collector 11. The cathode active material layer 12 includes one or more cathode active material layer structures, e.g., first, second, and third cathode active material layer structures 110, 120, and 130, respectively, wherein the first cathode active material layer structure is disposed in a direction from the second surface 12b to the first surface 12a. The one or more cathode active material layer structures include first, third, and fifth cathode active material layers 111, 121, and 131, respectively, and second, fourth, and sixth cathode active material layers 112, 122, and 132, respectively, disposed on the first, third, and fifth cathode active material layers 111, 121, and 131, respectively. The first, third, and fifth cathode active material layers 111, 121, and 131, respectively, each include one or more first, third, and fifth through-holes 113, 123, and 133, respectively, extending in the direction from the first surface to the second surface, and the second, fourth, and sixth cathode active material layers 112, 122, and 132, respectively, include one or more second, fourth, and sixth through-holes 114, 124, and 134, extending in the direction from the first surface to the second surface. In FIGS. 5 to 7, the number of the active material layers is 3, but may be 1, 2 or 4. Although not shown in the drawings, the first, third, and fifth cathode active material layers 111, 121, and 131, or the second, fourth, and sixth cathode active material layers 112, 122, and 132, respectively, may be additionally disposed on the first surface 12a and/or the second surface 12b of the cathode active material layer 12. The compositions and thicknesses of the one or more cathode active material layers included in the cathode active material layer structures may be changed to have different values from each other according to the desired energy density and/or discharge capacity of the battery. The number of cathode active material layers included in the cathode active material layer structures may be selected, e.g., increased or decreased according to the desired structure of the battery.

Referring to FIGS. 5 to 7, the one or more through-holes included in the active material layers, may be aligned in a first direction. For example, at least one first through-hole 113 included in the first cathode active material layer 111, at least one second through-hole 114 included in the second cathode active material layer 112, at least one third through-hole 123 included in the third cathode active material layer 121, at least one fourth through-hole 124 included in the fourth cathode active material layer 122, at least one fifth through-hole 133 included in the fifth cathode active material layer 131, and at least one sixth through-hole 134 included in the sixth cathode active material layer 132 may be aligned in a first direction (e.g., a Z direction) to form a channel structure 14. The channel structure 14 may comprise one or more channels 14a and 14b. Since the through-holes are aligned in the first direction to form the channel structure 14, the high-rate characteristic of the battery may be further improved.

Referring to FIG. 8, one or more of the through-holes included in the active material layers may be non-aligned (e.g., alternately arranged) in the first direction (e.g., the Z direction). The cathode active material layer 12 includes, for example, a first cathode active material layer structure 110, a second cathode active material layer structure 120, and a third cathode active material layer structure 130. The first cathode active material layer structure 110 includes a first cathode active material layer 111 and a second cathode active material layer 112 stacked on the first cathode active material layer 111 in the above direction. The first cathode active material layer 111 includes at least one first through hole 113 extending in the first direction, and the second cathode active material layer 112 includes at least one second through-hole 114 extending in the direction. The first through-hole 113 and the second through-hole 114 are non-aligned (e.g., alternately arranged) in the first direction (Z direction), so that the upper end of the first through-hole 113 may be blocked by the second cathode active material layer 112. The second cathode active material layer structure 120 includes a third cathode active material layer 121, and a fourth cathode active material layer 122 stacked on the third cathode active material layer 121 in the first direction. The third cathode active material layer 121 includes at least one third through-hole 123 extending in the first direction, and the fourth cathode active material layer 122 includes at least one fourth through-hole 124 extending in the first direction. The third through-hole 123 and the fourth through-hole 124 may be aligned in the first direction (Z direction) to form one or more channels 14a and 14b. The third cathode active material layer structure 130 includes a fifth cathode active material layer 131, and a sixth second cathode active material layer 132 stacked on the fifth cathode active material layer 131 in the first direction. The fifth cathode active material layer 131 includes at least one fifth through-hole 133 extending in the direction, and the sixth cathode active material layer 132 includes at least one sixth through-hole 134 extending in the direction. The fifth through-hole 133 and the sixth through-hole 134 may be aligned in the first direction (Z direction) to form one or more channels 14a and 14b. Accordingly, the cathode active material layer 12 has a channel structure 14 extending in a direction from the first surface 12a to the second surface 12b, and the channel structure 14 extends from the first cathode active material layer surface 12 to the 1-2 cathode active material layer 112. Since the channel structure 14 is separated from the current collector by the first cathode active material layer 111, localized lithium precipitation due to excessive current density on the surface of the current collector may be prevented.

Referring to FIGS. 5 to 8, one or more of the through-holes included in the cathode active material layers may be spaced apart from each other to provide a first pitch P1 and a second pitch P2 as shown in FIG. 6. The first pitch P1 between the one or more through-holes, which are spaced apart from each other, may be selected according to the desired energy density and/or discharge capacity of the battery. The second pitch P2 between the one or more through-holes, which are spaced apart from each other, may be adjusted according to the desired energy density and/or discharge capacity of the battery.

The first pitch P1 between the one or more first, third, and fifth through-holes 113, 123, and 133, respectively, which are spaced apart from each other, and the second pitch P2 between the one or more second, fourth, and sixth through-holes 114, 124, and 134, respectively, which are spaced apart from each other, are each independently, for example, about 100 μm to about 1000 μm, about 200 μm to about 700 μm, or about 300 μm to about 500 μm. Although not shown in the drawings, the first pitch P1 between the one or more first, third, and fifth through-holes 113, 123, and 133, respectively, which are spaced apart from each other, may be different from the second pitch P2 between the one or more second, fourth, and sixth through-holes 114, 124, and 134, respectively, which are spaced apart from each other. The first pitch may be about 10% to about 95%, about 10% to about 90%, or about 10% to about 80%, of the second pitch.

A first diameter D1 of each of the one or more first, third, and fifth through-holes 113, 123, and 133, respectively, and a second diameter D2 of each of the one or more second, fourth, and sixth through-holes 114, 124, and 134, respectively, are each independently, for example, about 0.5 μm to about 100 μm, about 1 μm to about 60 μm, or about 10 μm to about 40 μm.

Referring to FIG. 9, one or more of the cathode active material layer structures include first, third, and fifth cathode active material layers 111, 121, and 131, respectively, and second, fourth, and sixth cathode active material layers 112, 122, and 132, respectively, stacked on the first, third, and fifth cathode active material layers 111, 121, and 131, respectively, in the thickness direction. The first diameter D1 of each of the one or more first, third, and fifth through-holes 113, 123, and 133, respectively, included in each of the first, third, and fifth cathode active material layers 111, 121, and 131, respectively, may be different from the second diameter D2 of each of the one or more second, fourth, and sixth through-holes 114, 124, and 134, included in each of the second, fourth, and sixth cathode active material layers 112, 122, and 132, respectively. The first diameter D1 may be about 10% to about 95%, about 10% to about 90%, or about 10% to about 80%, of the second diameter D2.

Referring to FIG. 10, one or more cathode active material layer structures include cathode active material layers stacked in the thickness direction. The third thickness T3 of each portion of the first cathode active material layer 121, may be different from the fourth thickness T4 of each portion of the second cathode active material layers 132. The third thickness T3 may be smaller than the fourth thickness T4. The third thickness T3 is about 1% to about 95%, about 5% to about 90%, or about 10% to about 80%, of the fourth thickness T4. The third thickness T3 is, for example, about 1 μm to about 20, and the fourth thickness T4 is, for example, about 5 μm to about 100 μm.

Referring to FIGS. 5 to 10, when the one or more cathode active material layers are prepared through a sintering process, they may have a porous structure. Pores of the one or more cathode active material layers may comprise a liquid electrolyte (not shown) to be described later. In this case, the porous structures of the cathode active material layers may act as conducting channels of metal ions.

The one or more cathode active material layer structures include cathode active material layers stacked in the first direction, respectively. Each of the first, third, and fifth cathode active material layers 111, 121, and 131, respectively, may have a first porosity, each of the second, fourth, and sixth cathode active material layers 112, 122, 132, respectively, may have a second porosity, and the first porosity may be greater than the second porosity. The first porosity may be about 20% to about 60%, and the second porosity may be about 1% to about 10%, each based on a total volume of the respective cathode active material layers. The first porosity is a porosity of the first, third, and fifth cathode active material layers 111, 121, and 131, respectively, and the second porosity is a porosity of the second, fourth, and sixth cathode active material layers 112, 122, and 132, respectively. Each of the first, third, and fifth cathode active material layers 111, 121, and 131, respectively, may have a high first porosity, thereby providing a conducting path for metal ions between adjacent second, fourth, and sixth cathode active material layers 112, 122, and 132, respectively. Porosity and pore volume may be measured, for example, by nitrogen adsorption. The volume of the through-holes may be derived, for example, by measuring the diameter and depth of the through-holes through an SEM image.

A ratio (HV/PV) of the total hole volume (HV) of the first, third, and fifth through-holes formed in the cathode active material layers to the total pore volume (PV) of the first, third, and fifth cathode active material layers, respectively, may be, for example, about 0.1 to about 10, about 0.2 to about 5, or about 0.2 to about 3. As the ratio (HV/PV) increases, high-rate characteristics of the battery may be improved. Each of the first, third, and fifth cathode active material layers 111, 121, and 131, respectively, may include, for example, about 55 volume percent (vol %) of a cathode active material, based on a total volume of each cathode active material layer.

The ratio (HV/PV) of the total hole volume (HV) of the second, fourth, and sixth through-holes in the second, fourth, and sixth cathode active material layers 112, 122, and 132, respectively, to the total pore volume (PV) of the second, fourth, and sixth cathode active material layers 112, 122, and 132, respectively, having the second porosity is, for example, about 1 to about 100, about 2 to about 50, or about 2 to about 30. As the ratio (HV/PV) increases, high-rate characteristics of the battery may be improved. Each of the second, fourth, and sixth cathode active material layers 112, 122, and 132, respectively may include, for example, about 95 vol % of a cathode active material, based on a total volume of each cathode active material layer.

Referring to FIG. 10, the cathode active material layer 12 includes, for example, a first cathode active material layer structure 110, a second cathode active material layer structure 120, and a third cathode active material layer structure 130. The first cathode active material layer structure 110 includes a first cathode active material layer 111, and a second cathode active material layer 112 stacked on the first cathode active material layer 111 in the first direction. The first cathode active material layer 111 has a first porosity, and the second cathode active material layer 111 has a second porosity. The first porosity may be less than the second porosity, the first porosity may be about 20% to about 60%, and the second porosity may be about 1% to about 5%. The second cathode active material layer structure 120 includes a third cathode active material layer 121, and a fourth cathode active material layer 122 stacked on the third cathode active material layer 121 in the first direction. The third cathode active material layer 121 has a third porosity, and the fourth cathode active material layer 122 has a fourth porosity. The third porosity may be less than the fourth porosity, the third porosity may be about 20% to about 60%, and the fourth porosity may be about 1% to about 5%. The third cathode active material layer structure 130 includes a fifth cathode active material layer 131, and a sixth cathode active material layer 132 stacked on the fifth cathode active material layer 131 in the first direction. The fifth cathode active material layer 131 has a fifth porosity, and the sixth cathode active material layer 132 has a sixth porosity. The fifth porosity may be less than the sixth porosity, the fifth porosity may be about 20% to about 60%, and the sixth porosity may be about 1% to about 5%.

Referring to FIGS. 5 to 10, the first, third, and fifth cathode active material layers 111, 121, and 131, respectively, and the second, fourth, and sixth cathode active material layers 112, 122, and 132, respectively, may be, for example, sintered layers formed through a sintering process, respectively. The sintered layer may provide an increased density compared to a mixture layer including cathode active material particles. Accordingly, the energy density of a battery employing the cathode 10 including the first, third, and fifth cathode active material layers 111, 121, and 131, respectively, and the second, fourth, and sixth cathode active material layers 112, 122, and 132, respectively, may be improved.

The sintered cathode active material layer 12 including the first, third, and fifth cathode active material layers 111, 121, and 131, respectively, and the second, fourth, and sixth cathode active material layers 112, 122, and 132, respectively, may include a plurality of crystallites, and the plurality of crystallites may be aligned in the first direction. Major axes of the plurality of crystallites may be arranged, for example, in the channel direction. Major axes of the plurality of crystallites may be arranged in the second direction (X direction) or third direction (Y direction) to be arranged in the surface direction of the channels 14a and 14b.

The first, third, and fifth cathode active material layers 111, 121, and 131, respectively, and the second, fourth, and sixth cathode active material layers 112, 122, and 132, respectively, may be binder-free layers containing no binder because a binder is removed by heat treatment during a sintering process. Since the first, third, and fifth cathode active material layers 111, 121, and 131, respectively, and the second, fourth, and sixth cathode active material layers 112, 122, and 132, respectively, do not contain a binder, energy density of the cathode active material layer 12 may be improved. The cathode active material layer 12 may be a sintered layer, and may be a binder-free layer.

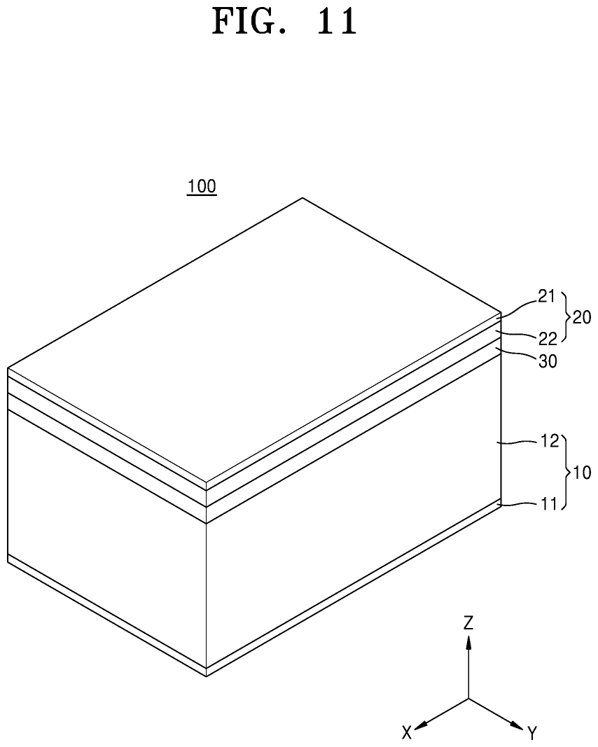

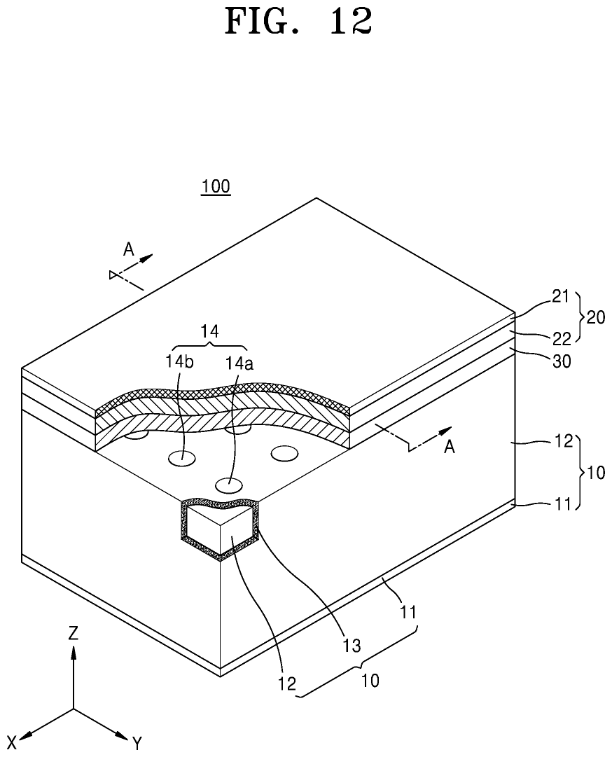

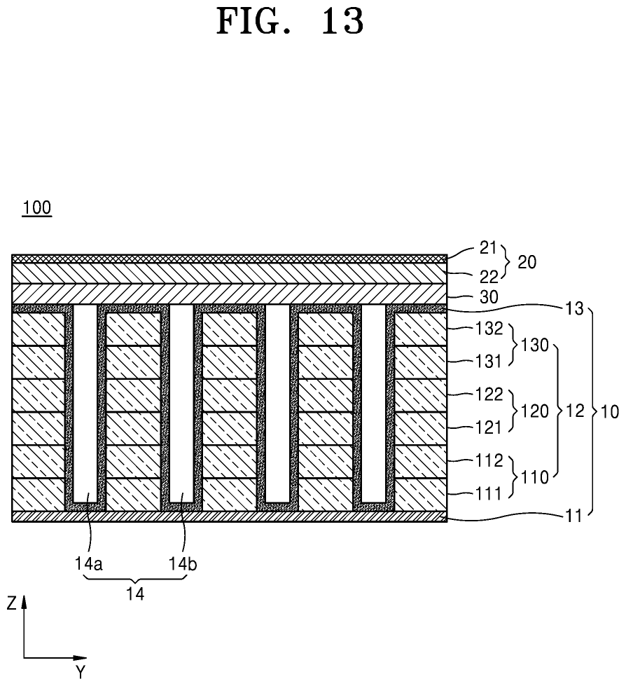

FIG. 11 is a perspective view schematically illustrating a structure of an electrochemical battery 100 according to an embodiment. FIG. 12 is a partial cross-sectional view partially illustrating the inside of the electrochemical battery 100 of FIG. 11. FIG. 13 is a cross-sectional view of the electrochemical battery 100 of FIG. 12 taken along line A-A in FIG. 2.

Referring to FIGS. 11 to 13, the electrochemical battery 100 includes: the cathode 10; an anode 20; a separator 30 between the cathode and the anode; and a liquid electrolyte in the separator 30.

A liquid electrolyte is disposed between the cathode 10 and the anode 20, and metal ions, such as lithium ions and sodium ions, contained in the liquid electrolyte are easily transferred into the cathode active material layer 12 through the channels 14a and 14b constituting the channel structure 14 of the cathode 10, so that the cycle characteristics of the electrochemical battery 100 including the cathode 10 are improved. Further, since the conductive metal layer 13 is disposed on the surfaces of the channels 14a and 14b of the channel structure 14, a side reaction between the liquid electrolyte and the cathode active material layer 12 is suppressed and non-uniformity of current density on the surface of the cathode active material layer 12 is resolved, so that the cycle characteristics of the electrochemical battery 100 are improved. The separator 30 blocks a contact between the cathode 10 and the anode 20 to prevent a short circuit. Further, the separator 30 may comprise a pore with the liquid electrolyte ionically conducts the cathode 10 and the anode 20 and electronically blocks the cathode 10 and the anode 20.

The electrochemical battery 100 is, for example, a lithium battery and is manufactured by the following exemplary method, but is not necessarily limited to this method and may be modified according to desired conditions.

The cathode 10 is prepared according to a method of manufacturing a cathode to be described later.

The anode 20 is manufactured as follows. For example, an anode active material, a conducting agent, a binder, and a solvent are mixed to prepare an anode active material composition. The anode active material composition is directly applied onto an anode current collector 21 and dried to prepare an anode 20 in which an anode active material layer 20 is disposed on the anode current collector 21. Alternatively, the anode active material composition is cast on a separate support to form an anode active material layer 22, and the anode active material layer 22 is separated from the support, disposed on the anode current collector 21, and then laminated to prepare an anode 20.

The anode current collector 21 may comprise a conductive metal such as Cu, Au, Pt, Ag, Zn, Al, Mg, Ti, Fe, Co, Ni, Ge, In, Pd, stainless steel, or a combination thereof, but the material thereof is not necessarily limited thereto, and any suitable material may be used. For example, the anode current collector 21 is a copper (Cu) foil.

The anode active material is not particularly limited, and any suitable material may be used. The anode active material is, for example, an alkali metal (e.g., lithium, sodium, potassium), an alkaline earth metal (e.g., calcium, magnesium, barium) and/or a transition metal (e.g., zinc) or an alloy thereof. The anode active material is, for example, lithium metal, a metal alloyable with lithium, a transition metal oxide, a non-transition metal oxide, a carbon-based material, or a combination thereof. The anode active material is, for example, lithium metal. When lithium metal is used as the anode active material, the anode current collector may be omitted or not omitted. When the anode current collector is omitted, the energy density per unit weight of a lithium battery is improved because the volume and weight occupied by the anode current collector are reduced. The anode active material is, for example, an alloy of lithium metal and another anode active material. Another anode active material is, for example, a metal alloyable with lithium. Examples of the metal alloyable with lithium include Si, Sn, Al, Ge, Pb, Bi, Sb, an Si—Y′ alloy (Y′ is an alkali metal, an alkali-earth metal, a Group 13 element, a Group 14 element, a transition metal, an rare earth element, or a combination thereof, not Si), and an Sn—Y′ alloy (Y′ is an alkali metal, an alkali-earth metal, a Group 13 element, a Group 14 element, a transition metal, an rare earth element, or a combination thereof, not Sn). The element Y′ is, for example, Mg, Ca, Sr, Ba, Ra, Sc, Y, Ti, Zr, Hf, Rf, V, Nb, Ta, db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ge, P, As, Sb, Bi, S, Se, Te, Po, or a combination thereof. The lithium alloy is, for example, a lithium-aluminum alloy, a lithium-silicon alloy, a lithium-tin alloy, a lithium-silver alloy, or a lithium-lead alloy. The anode active material is, for example, a transition metal oxide. The transition metal oxide is, for example, lithium titanium oxide, vanadium oxide, or lithium vanadium oxide. The anode active material is, for example, a non-transition metal oxide. The non-transition metal oxide is, for example, SnO₂ or SiOₓ (0<x<2). The anode active material is, for example, a carbon-based material. The carbon-based material is, for example, crystalline carbon, amorphous carbon, or a mixture thereof. The crystalline carbon is, for example, graphite such as amorphous, plate-like, flake-like, spherical or fibrous natural graphite or artificial graphite. The amorphous carbon is, for example, soft carbon (low-temperature fired carbon), hard carbon, mesophase pitch carbide, or sintered coke.

The contents of the anode active material, the conducting agent, the binder, and the solvent are at levels commonly used in lithium batteries. Depending on the use and configuration of the lithium battery, one or more of the conducting agent, the binder, and the solvent may be omitted.

The content of the binder included in the anode is, for example, about 0.1 weight percent (wt %) to about 10 wt %, or about 0.1 wt % to about 5 wt % of the total weight of the anode active material layer. The content of the conducting agent included in the anode is, for example, about 0.1 wt % to about 10 wt %, or about 0.1 wt % to about 5 wt % of the total weight of the anode active material layer. The content of the anode active material included in the anode is, for example, about 90 wt % to about 99 wt %, or about 95 wt % to about 99 wt % of the total weight of the anode active material layer. When the anode active material is lithium metal, the anode may not include a binder and a conducting agent.

Next, a separator to be inserted between the cathode 10 and the anode 20 is prepared.

As the separator 30, any separator used in electrochemical batteries may be used. As the separator 30, for example, a separator having low resistance to ion movement of an electrolyte and an excellent electrolyte-moisturizing ability is used. The separator 30 is a non-woven fabric or a woven fabric including fiberglass, polyester, Teflon, polyethylene, polypropylene, polytetrafluoroethylene (PTFE), or a combination thereof. For an electrochemical battery, for example, a rollable separator including polyethylene, or polypropylene is used.

The separator may be manufactured by the following method, but the present disclosure is not necessarily limited to this method and is adjusted as desired.

First, a polymer resin, a filler, and a solvent are mixed to prepare a separator composition. The separator composition is directly applied and dried on an electrode to form a separator. Alternatively, a film obtained by casting and drying the separator composition on a support then separating the composition from the support, is laminated on the electrode to form a separator. The polymer used for manufacturing the separator is not particularly limited, and any polymer used for the binder of an electrode plate may be used. For example, as the polymer, a vinylidene fluoride/hexafluoropropylene copolymer, polyvinylidene fluoride (PVDF), polyacrylonitrile, polymethyl methacrylate, or a mixture thereof may be used.

Next, a liquid electrolyte is prepared.

The liquid electrolyte is, for example, an anhydrous electrolyte. The liquid electrolyte is, for example, an organic electrolyte. The organic electrolyte is prepared, for example, by dissolving a lithium salt in an organic solvent.

As the organic solvent, any suitable organic solvent may be used, e.g., a solvent used in the art. The organic solvent is, for example, propylene carbonate, ethylene carbonate, fluoroethylene carbonate, butylene carbonate, dimethyl carbonate, diethyl carbonate, methyl ethyl carbonate, methyl propyl carbonate, ethyl propyl carbonate, methyl isopropyl carbonate, dipropyl carbonate, dibutyl carbonate, benzonitrile, acetonitrile, tetrahydrofuran, 2-methyltetrahydrofuran, γ-butyrolactone, dioxolane, 4-methyldioxolane, N,N-dimethylformamide, dimethylacetamide, dimethylsulfoxide, dioxane,1,2-dimethoxyethane, sulfolane, dichloroethane, chlorobenzene, nitrobenzene, diethylene glycol, dimethyl ether, or a combination thereof.

As the lithium salt, any suitable lithium salt may be used, e.g., a lithium salt used in the art. The lithium salt is, for example, LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂)(here, x and y are each 1 to 20), LiCl, LiI, or a mixture thereof. The concentration of the lithium salt included in the liquid electrolyte is, for example, about 0.1 molar (M) to about 10 M, or about 0.1 M to about 5 M.

As shown in FIGS. 11 to 13, an electrochemical battery 100 includes a cathode 10, an anode 20, and a separator 30. The cathode 10, the anode 20, and the separator 30 are stacked, wound or folded to be accommodated in a battery case (not shown). A liquid electrolyte is injected into the battery case, and the battery case is sealed to complete the electrochemical battery 100. The battery case has, for example, a square shape, a thin film shape, a cylindrical shape, but the shape thereof is not necessarily limited thereto.

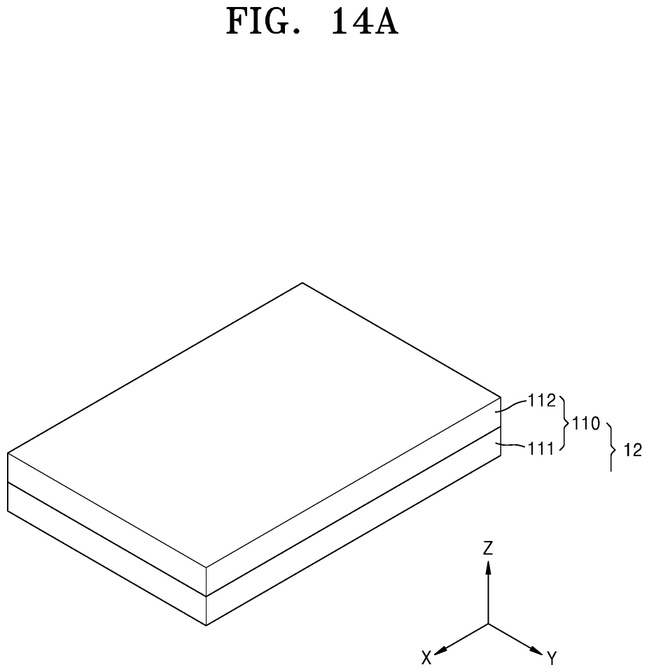

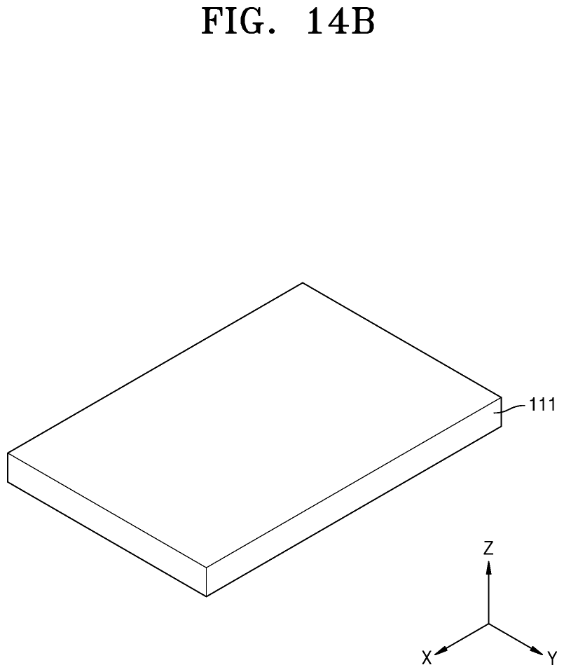

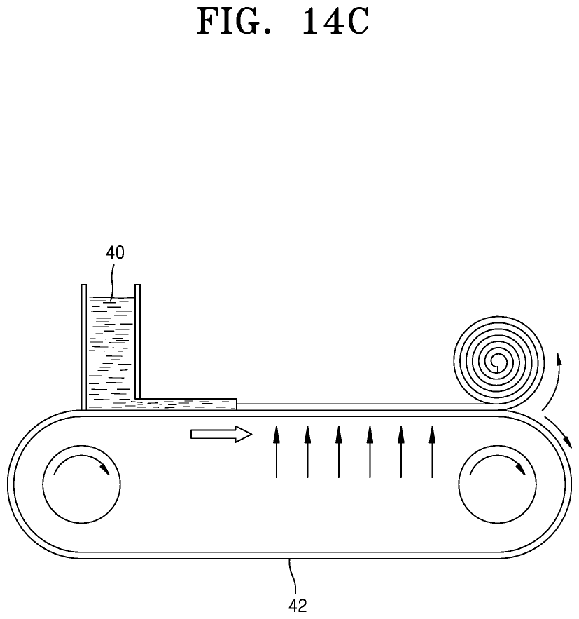

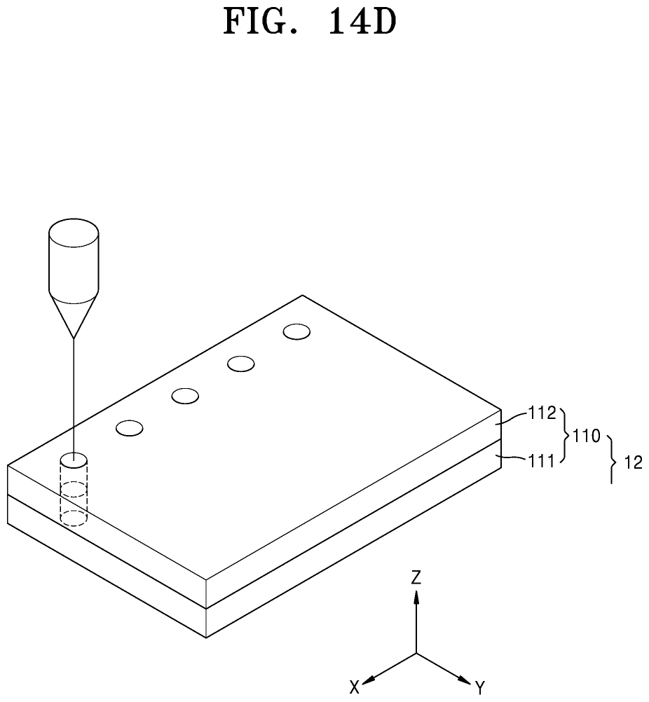

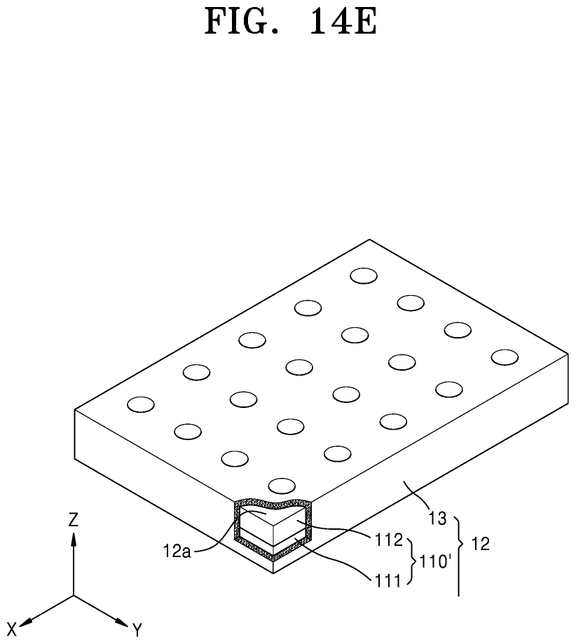

FIGS. 14A to 14E are perspective views for explaining a method of manufacturing a cathode.

A method of manufacturing a cathode according to an embodiment includes: providing a cathode active material layer having a first surface and a second surface opposite the first surface and having a channel structure extending in a direction from the first surface to the second surface; and placing a conductive metal layer on the surfaces of one or more channels of the channel structure.

Referring to FIG. 14A, first, a cathode active material layer 12 including a cathode active material layer structure 110 is provided. The cathode active material layer structure 110 includes, for example, a first cathode active material layer 111 and a second cathode active material layer 112. The first cathode active material layer 111 and the second cathode active material layer 112 may be stacked in the first direction (Z direction) to form the cathode active material layer structure 110. The first cathode active material layer 111 and the second cathode active material layer 112 may have a uniform sintered density. The first cathode active material layer 111 and the second cathode active material layer 112 may be prepared by, for example, a tape casting method.

Referring to FIGS. 14B and 14C, a cathode active material, a conducting agent, a binder, and a solvent are mixed to prepare a first cathode active material composition 40.

The cathode active material is not particularly limited, and any cathode active material used in the art may be used. The cathode active material may be, for example, a compound (lithiated intercalation compound) capable of reversible intercalation and deintercalation of lithium. The cathode active material includes, for example, a lithium transition metal oxide of e.g., lithium cobalt oxide, lithium nickel cobalt manganese oxide, lithium nickel cobalt aluminum oxide, lithium iron phosphate, lithium manganese oxide, or a combination thereof. Specifically, the cathode active material includes, for example, lithium cobalt oxide of Formula LiCoO₂; lithium nickel oxide of Formula LiNiO₂; lithium manganese oxide of Li₁₊ₓMn₂₋ₓO₄ (0≤x≤0.33), LiMnO₃, LiMn₂O₃, or LiMnO₂; lithium copper oxide of Formula Li₂CuO₂; lithium iron oxide of Formula LiFe₃O₄; lithium vanadium oxide of Formula LiV₃O₈; copper vanadium oxide of Formula Cu₂V₂O₇; vanadium oxide of F formula V₂O₅; lithium nickel oxide of Formula LiNi₁₋ₓMₓO₂ (where M=Co, Mn, Al, Cu, Fe, Mg, B or Ga, and x=0.01 to 0.3); lithium manganese composite oxide of Formula LiMn₂₋ₓMₓO₂ (where M=Co, Ni, Fe, Cr, Zn or Ta, and x=0.01 to 0.1) or Li₂Mn₃MO₈ (where M═Fe, Co, Ni, Cu or Zn); lithium manganese oxide in which a part of Li of Formula LiMn₂O₄ is substituted with an alkaline earth metal ion; a disulfide compound; iron molybdenum oxide of Formula Fe₂(MoO₄)₃, or a combination thereof. The cathode active material is, for example, LiCoO₂, LiNiO₂, LiMn₂O₄, or LiFePO₄.

The cathode active material is, for example, LiₐCoₓM_{y}O_{2-b}A_{b} (where, 1.0≤a≤1.2, 0≤b≤0.2, 0.9≤x≤1, 0≤y≤0.1, and x+y=1 are satisfied, M is manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and A is F, S, Cl, Br, or a combination thereof; LiₐNiₓCo_{y}M_{z}O_{2-b}A_{b} (where, 0.9≤a≤1.2, 0.8≤x≤0.95, and 0≤y≤0.2 are satisfied, M is manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and A is F, S, CI, Br, or a combination thereof); LiNiₓCo_{y}Mn_{z}O₂ (where, 0.8≤x<1.0, 0<y≤0.2, 0<z≤0.2, and x+y+z=1); LiNiₓCo_{y}Al_{z}O₂ (where, 0.8≤x<1.0, 0<y≤0.2, 0<z≤0.2, and x+y+z=1); or LiNiₓCo_{y}MnᵥAl_{w}O₂ (where, 0.8≤x<1.0, 0<y≤0.2, 0<z≤0.2, 0<v≤0.2, 0<w≤0.2, and x+y+v+w=1). The cathode active material is particularly LiCoO₂.

As the conducting agent, for example, carbon black, graphite fine particles, natural graphite, artificial graphite, acetylene black, ketjen black, carbon fiber, carbon nanotubes, metal powder, metal fiber or metal tube of coper, nickel, aluminum or silver, or a conductive polymer such as a polyphenylene derivative is used. However, the present disclosure is not limited thereto, and any conducting agent used in the art may be used.

As the binder, for example, a vinylidene fluoride/hexafluoropropylene copolymer, polyvinylidene fluoride, polyacrylonitrile, polymethyl methacrylate, polytetrafluoroethylene (PTFE), a mixture of the above polymers, or styrene butadiene rubber-based polymer is used. As the solvent, for example, N-methylpyrrolidone (NMP), acetone, or water is used. However, the present disclosure is not limited thereto, and any solvent used in the art may be used.

The contents of the cathode active material, the conducting agent, the binder, and the solvent used in the first cathode active material composition 40 are levels commonly used in electrochemical batteries. One or more of the conducting agent, the binder, and the solvent may be omitted depending on the use and configuration of an electrochemical battery.

The first cathode active material composition 40 may be applied onto a transfer belt 42. For example, the transfer belt 42 may move in a first direction, and the first cathode active material composition 40 may be provided on the moving transfer belt 42. The first cathode active material composition 40 may be applied onto the transfer belt 42 to a uniform thickness. For example, a doctor blade (not shown) may control the thickness of the first cathode active material composition 40 applied on the transfer belt 42 to be uniform.

The first cathode active material composition 40 applied on the transfer belt 42 may be dried to form a first cathode active material layer 111 having a large area. For example, the first cathode active material composition 40 may be dried by a heating process. In the large-area first cathode active material layer, cathode active material particles may be bound by a binder. The large-area first cathode active material layer may be cut to form the first cathode active material layer 111 shown in FIG. 14A.

The method of manufacturing the second cathode active material layer 112 may also be performed by the tape casting method shown in FIG. 14C in substantially the same manner as the method of manufacturing the first cathode active material layer 111.

For example, a second cathode active material composition having a different composition from the first cathode active material composition may be prepared. The second cathode active material composition is prepared by mixing a cathode active material, a conducting agent, a binder, and a solvent. The cathode active material included in the second cathode active material composition may be different from the cathode active material included in the first cathode active material composition in one or more physical properties such as composition and particle size. The second cathode active material composition 40 is applied onto the transfer belt 42 and dried to form a second cathode active material layer 112 having a large area, and the second cathode active material layer 112 is cut to form the second cathode active material layer 112 shown in FIG. 14A.

The second cathode active material layer 112 may be stacked on a first surface of the first cathode active material layer 111 to form a first cathode active material layer structure 110. The direction in which the second cathode active material layer 112 is stacked may be a thickness direction, that is, a first direction (Z direction). When a plurality of cathode active material layer structures are to be formed, a process of stacking the first cathode active material layer 111 and the second cathode active material layer 112 in the first direction (Z direction) may be repeatedly performed.

Next, referring to FIGS. 14A and 14D, a channel structure 14 is provided to the cathode active material layer 12 including the cathode active material layer structure 110. The channel structure 14 may be provided to extend in a direction from the first surface 12a of the cathode active material layer to the second surface 12b of the cathode active material layer opposite the first surface 12a thereof, that is, in the first direction (Z direction) or the thickness direction.

For example, one or more first through-holes 113 extending in the thickness direction of the first cathode active material layer 111, and one or more second through-holes 114 extending in the thickness direction of the second cathode active material layer 112 may be formed to provide a channel structure.

One or more first through-holes 113 and one or more second through-holes 114 may be formed by laser drilling. For example, one or more first through-holes 113 and one or more second through-holes 114, formed by laser drilling, have a tortuosity of about 1 to about 1.5. Accordingly, one or more first through-holes 113 and one or more second through-holes 114, may form channels extending substantially linearly in the thickness direction, that is, the first direction (Z direction)

Next, the cathode active material structure 110 may be sintered. For example, the cathode active material structure 110 may be formed through a sintering process, and thus a cathode active material structure having a binder-free structure from which a binder is removed may be implemented. For example, the ratio (HV/PV) of the sum (HV) of volumes of the plurality of second through-holes 114 to the sum (PV) of volumes of pores provided in the second cathode active material layer 112 is about 0.2 to about 7. When there is a plurality of cathode active material structures, the plurality of cathode active material structures may be stacked in the thickness direction, that is, in the first direction (Z direction), and then through-holes may be formed using laser drilling and sintered.

For example, a cathode current collector 11 may be on a first surface of the cathode active material structure 110. For example, the cathode current collector 11 may have a plate shape, and in this case, it may be referred to as a current collecting plate. The cathode current collector 11 may be on a second surface opposite the first surface of the active material structure 110.

Alternatively, although not shown in the drawings, before the first cathode active material layer 111 and the second cathode active material layer 112 are stacked in the first direction (Z direction) to form the cathode active material layer structure 110, at least one first through-hole 113 and at least one second through-hole 114 may be formed in each of the first cathode active material layer 111 and the second cathode active material layer 112, respectively. By this method, each of the first cathode active material layer 111 and the second cathode active material layer 112 may include through-holes having various shapes and positions. In addition, the plurality of cathode active material layer structures may have different through-hole positions, or sizes. Accordingly, when there is a plurality of cathode active material structures included in the cathode active material layer 12, various types of channel structures 14 may be introduced into the cathode active material layer 12.

Next, referring to FIGS. 2 and 14E, in the cathode active material layer 12 to which the channel structure 140 is introduced, a conductive metal layer 13 is disposed on the surfaces of one or more channels 14a and 14b of the channel structure 14.

The conductive metal layer 13 may be on the surfaces of one or more channels 14a and 14b and the first surface 12a of the cathode active material layer 12.

The conductive metal layer 13 may be formed, for example, by a dry method. The conductive metal layer 13 may be formed, for example, by sputtering, atomic layer deposition (“ALD”), chemical vapor deposition (“CVD”), or physical vapor deposition (“PVD”). Particularly, the conductive metal layer 13 may be formed by ALD. A thin film having a thickness of about 1 nanometer (nm) to about 50 nm may be uniformly formed. Accordingly, in the cathode active material layer 12 to which the channel structure 14 is introduced, a difference in the thickness of the conductive coating layer between the first surface 12a of the cathode active material layer 12 and the surfaces of the channels 14a and 14b, may be minimized.

Hereinafter, the present disclosure will be described in more detail through the following Examples and Comparative Examples. However, these Examples are intended to illustrate the present disclosure, and the scope of the present disclosure is not limited thereto.

### EXAMPLES

### (Manufacture of Cathode and Lithium Battery)

### Example 1: Single-Composition 3D Anode, Ru Coating

### (Manufacture of Cathode)

A slurry including LiCoO₂ powder having an average particle diameter (D50) of about 1 μm, polyvinyl butyral as a binder, dibutyl phthalate as a plasticizer, an ester-based surfactant as a dispersant, and a mixture of toluene and ethanol under azeotropic conditions as a solvent at a predetermined ratio was applied onto a transfer belt using the above-described tape casting method to form a sheet, and the sheet was dried at 200° C. to prepare a first cathode active material sheet having a thickness of 20 μm.

A second cathode active material sheet having the same thickness was prepared in the same manner as in the first cathode active material sheet. The second cathode active material sheet was arranged on the first cathode active material sheet to prepare a first cathode active material layer structure.

A plurality of cathode active material layer structures was prepared in the same manner as in the first cathode active material layer structure. The plurality of cathode active material layer structures was sequentially stacked on the first cathode active material layer structure to prepare a three-dimensional cathode active material layer structure.

A plurality of through-holes penetrating from a first surface of the three-dimensional cathode active material layer structure to the second surface opposite the first surface thereof was formed by laser drilling.

A current collector slurry including an Ag—Pd alloy was applied onto the second surface of the three-dimensional cathode active material layer structure provided with the through-holes using a screen printing method to form a current collector layer.

The three-dimensional cathode active material layer structure provided with the through-holes is aligned on the current collector layer, and sintered at 1025° C. for 2 hours under an air atmosphere to prepare a cathode including a three-dimensional cathode active material layer having a channel structure.

Ruthenium (Ru) was deposited on the first surface of the cathode active material layer having a channel structure by atomic layer deposition (ALD), and thereby, a conductive metal layer was disposed on the surfaces of the channels constituting the channel structure and on the first surface of the cathode active material layer.

The thickness of the conductive metal layer was 5 nm. The manufactured cathode may have the structure of FIG. 7. The conductive metal layer is omitted in FIG. 7.

### (Manufacture of Lithium Battery)

98 wt % of artificial graphite (BSG-L, Tianjin BTR New Energy Technology Co., Ltd.), 1.0 wt % of a styrene-butadiene rubber (SBR) binder (ZEON), 1.0 wt % of a styrene-butadiene rubber (SBR) binder (ZEON), and 1.0 wt % of carboxymethyl cellulose (CMC, NIPPON A&L), based on a total weight of the graphite, SBR and CMC, were mixed to obtain a mixture, and then distilled water was added to the mixture to obtain a mixed solution, and the mixed solution was stirred for 60 minutes using a mechanical stirrer to prepare an anode active material slurry. The slurry was applied onto a copper current collector having a thickness of 10 μm to about 60 μm using a doctor blade, dried at 100° C. for 0.5 hours using a hot air dryer, dried in vacuum at 120° C. for 4 hours one more time, and roll-pressed to prepare an anode.

A lithium battery was manufactured using the above-described cathode and anode and using a ceramic-coated polyethylene separator having a thickness of 14 μm and a solution in which 1.15 M LiPF6 was dissolved in EC (ethylene carbonate)+EMC (ethyl methyl carbonate)+DMC (dimethyl carbonate) (3:4:3 volume ratio) as an electrolyte.

### Example 2: Single-Composition 3D Cathode, Al Coating

A cathode having a conductive metal layer, and a lithium battery were prepared in the same manner as in Example 1, except that Al coating was used instead of Ru coating.

### Example 3: Multi-Composition 3D Cathode, Ru Coating

A slurry including LiCoO₂ powder having an average particle diameter (D50) of about 2 μm, polyvinyl butyral as a binder, dibutyl phthalate as a plasticizer, an ester-based surfactant as a dispersant, and a mixture of toluene and ethanol under azeotropic conditions as a solvent at a predetermined ratio was applied onto a transfer belt using the above-described tape casting method to form a sheet, and the sheet was dried at 200° C. to prepare a first cathode active material sheet having a thickness of 5 μm. The content of LiCoO₂ in the first cathode active material sheet was 55 vol %, based on a total volume of the first cathode active material layer.

A slurry including LiCoO₂ powder having an average particle diameter (D50) of about 0.3 μm, polyvinyl butyral as a binder, dibutyl phthalate as a plasticizer, an ester-based surfactant as a dispersant, and a mixture of toluene and ethanol under azeotropic conditions as a solvent at a predetermined ratio was applied onto a transfer belt using the above-described tape casting method to form a sheet, and the sheet was dried at 200° C. to prepare a second cathode active material sheet having a thickness of 20 μm. The content of LiCoO₂ in the second cathode active material sheet was 95 vol %, based on a total volume of the first cathode active material layer.

A cathode and a lithium battery were manufactured in the same manner as in Example 1, except that the prepared first cathode active material sheet and second cathode active material sheet were used, respectively.

The manufactured cathode may have the structure of FIG. 10. The conductive metal layer is omitted in FIG. 7.

### Comparative Example 1: Conductive Metal Layer-Free

A cathode and a lithium battery were manufactured in the same manner as in Example 1, except that the process of placing a conductive metal layer was not performed.

### Evaluation Example 1: Measurement of Conductivity

Each of the cathodes prepared in Example 1 and Comparative Example 1 and an electrode in which a Si wafer is coated with Ru, were used as cathodes, respectively, a Li foil was used as an anode, and the electrolyte of Example 1 was used as an electrolyte to prepare a half-cell.

After the prepared half-cell was charged and discharged once and subjected to a formation process, the impedance of the half-cell e was measured, and the conductivity of the half-cell was calculated from the measured impedance and shown in Table 1 below.

The impedance of the battery was measured by a two-probe method using an impedance analyzer (Solartron, 1400A/1455A impedance analyzer). The frequency range was about 0.1 Hz to about 1 MHz, and the amplitude of the voltage was 10 mV.

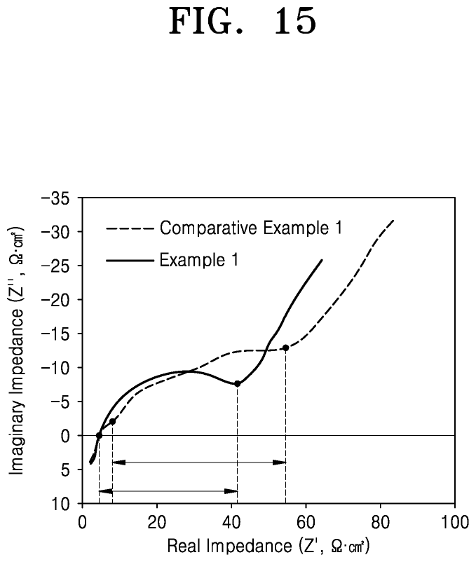

The impedance was measured at 25° C. under an air atmosphere. With respect to the impedance measurement results, Nyquist plots for the half-cell including the cathode of Example 1 and the half-cell including the cathode of Comparative Example 1 are shown in FIG. 15.

TABLE 1

| | Conductivity |
|---|---|
| | [Siemens per centimeter, S/cm] |
| Cathode of Example 1 | 2.04 × 10⁻² |
| Cathode of Comparative | 1.93 × 10⁻⁵ |
| Example 1 | |
| Si wafer coated with Ru | 2.8 × 10⁴ |

As shown in Table 1 and FIG. 15, it was found that interfacial resistance decreased, and electronic conductivity increased by placing the conductive Ru coating layer on the cathode active material layer.

### Evaluation Example 2: XPS Spectrum Evaluation (I)

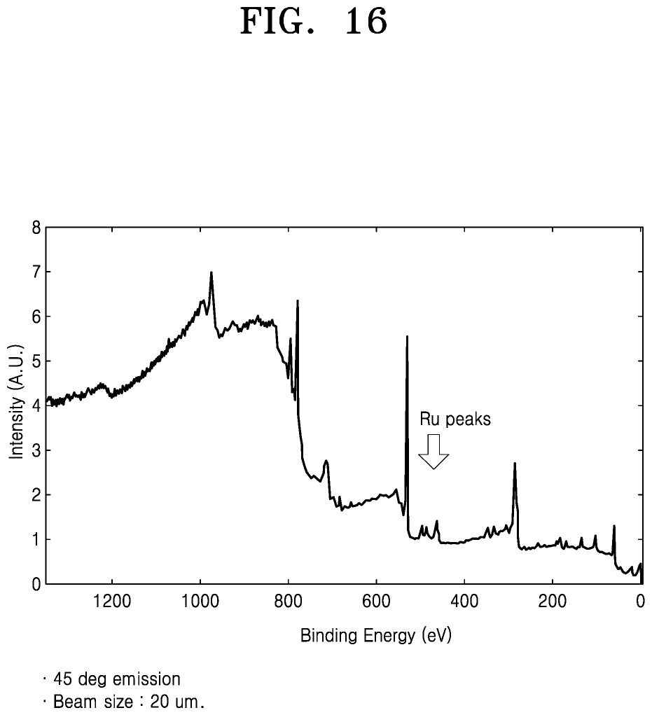

For the cathode prepared in Example 1, XPS spectrum was measured using Qunatum 2000 (Physical Electronics), and is shown in FIG. 16.

As shown in FIG. 16, a peak for the Ru metal element was confirmed in the anode prepared in Example 1.

Accordingly, it was found that the conductive metal layer including Ru metal was deposited on the first surface of the positive electrode active material layer and on the surface of the channel of the positive electrode active material layer.

### Evaluation Example 3: XPS Spectrum Evaluation (II)

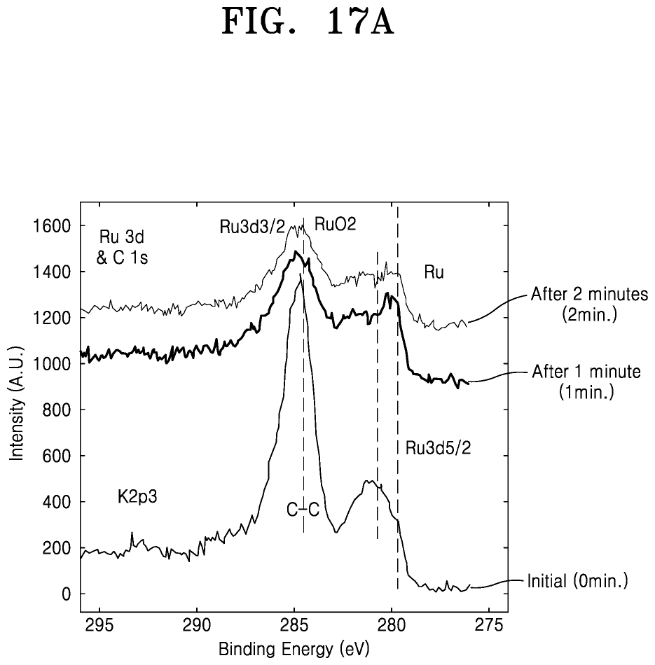

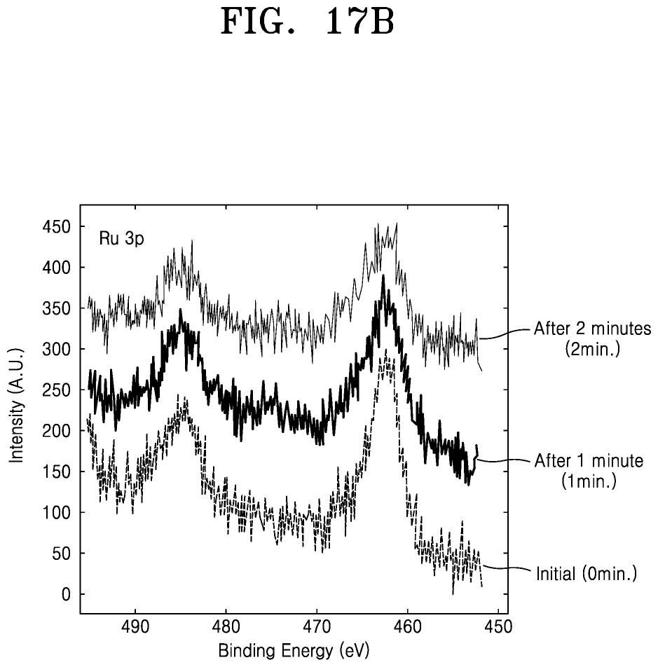

For the cathode prepared in Example 1, XPS spectrum over time was measured using Qunatum 2000 (Physical Electronics), and the results thereof are shown in FIGS. 17A and 17B.

XPS spectra of C 1s orbital and Ru 3d orbital of the sample after initial, 1 minute, and 2 minutes were measured, respectively.

In FIG. 17A, initially, the peak of RuO₂ near 281 eV was larger than the peak of Ru near 280 eV. This result was confirmed to be due to the RuO₂ oxide layer arranged on the Ru metal layer.

After 1 minute, a peak of RuO₂ decreased, and a peak of Ru increased. This result was confirmed to be due to the Ru metal layer.

After 2 minutes, a peak due the oxide at 281 eV increased again, but it was confirmed as a peak due to LiCoO₂, which is a cathode active material.

Accordingly, it was found that the Ru conductive metal layer was disposed on the cathode active material layer and the RuO₂ metal oxide layer was disposed on the Ru conductive metal layer.

The presence of Ru metal was confirmed in FIG. 17B.

### Evaluation Example 4: Evaluation of Charge-Discharge Characteristics

Each of the lithium batteries manufactured in Example 1 and Comparative Example 1 was charged with a constant current of 0.1 C rate at 25° C. until a voltage reached 4.30 V (vs. Li), and was then cut-off at a current of 0.05 C rate while maintaining 4.30 V at a constant voltage mode. Subsequently, the lithium battery was discharged with a constant current of 0.1 C rate until the voltage reached 2.8 V (vs. Li) during discharging (formation process, 1st cycle). The C rate is a discharge rate of a cell, and is obtained by dividing a total capacity of the cell by a total discharge period of time of 1 hour, e.g., a C rate for a battery having a discharge capacity of 1.6 ampere-hours would be 1.6 amperes.

The lithium battery having passed through the formation process was charged with a constant current of 0.2 C rate at 25° C. until the voltage reached 4.30 V (vs. Li), and was then cut-off at a current of 0.05 C rate while maintaining 4.30 V at a constant voltage mode. Subsequently, the lithium battery was discharged with a constant current of 0.2 C rate until the voltage reached 2.8 V (vs. Li) during discharge (formation process, 2^{nd} cycle).

The lithium battery having passed through the formation process was charged with a constant current of 1.0 C rate at 25° C. until the voltage reached 4.30 V (vs. Li), and was then cut-off at a current of 0.05 C rate while maintaining 4.30 V at a constant voltage mode. Subsequently, the lithium battery was discharged with a constant current of 1.0 C rate until the voltage reached 2.75 V (vs. Li) during discharge. This cycle was repeated until the 280^{th} cycle.

After one charge/discharge cycle in all the above charge/discharge cycles, there was a stop time of 10 minutes.

Some of the results of the charge and discharge experiments are shown in Table 3 and FIG. 17 below. The capacity retention in the 280^{th} cycle is defined by Equation 2.

Capacity loss=[(Discharge capacity in 2^{nd} cycle (0.2C)−Discharge capacity in 3^{rd} cycle (1C))/Discharge capacity in 2^{nd} cycle (0.2C)]×100% Equation 1

Capacity retention=[Discharge capacity in 280^{th} cycle/Discharge capacity at 1^{st} cycle]×100% Equation 2

TABLE 2

| | Capacity loss in | Capacity retention in |
|---|---|---|
| | 3^{rd} cycle [%] | 280^{th} cycle [%] |
| Example 1 | 5 | 85.9 |
| Comparative | 6 | 79.4 |
| Example 1 | | |

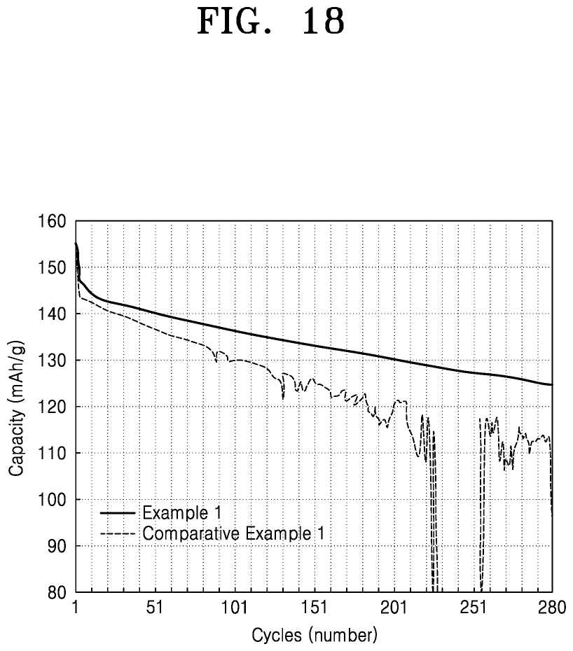

As shown in Table 2 and FIG. 18, in the lithium battery of Example 1, a capacity loss at a high rate was increased and lifespan characteristics at a high rate were improved compared to the lithium battery of Comparative Example 1.

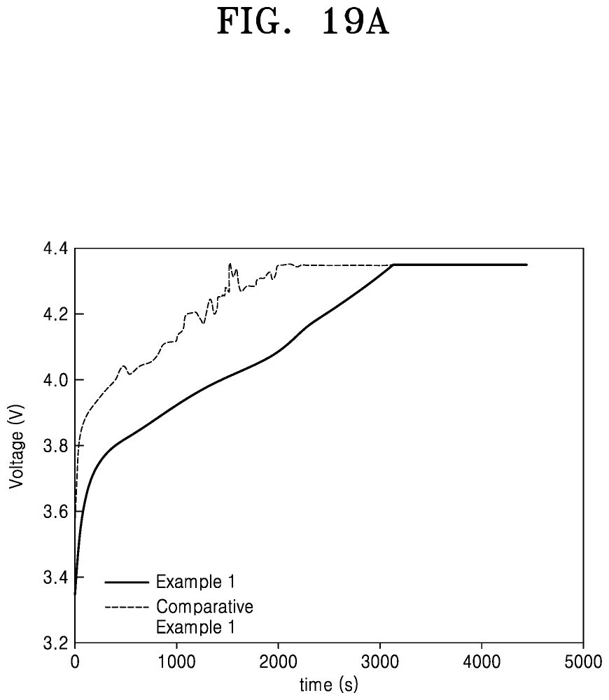

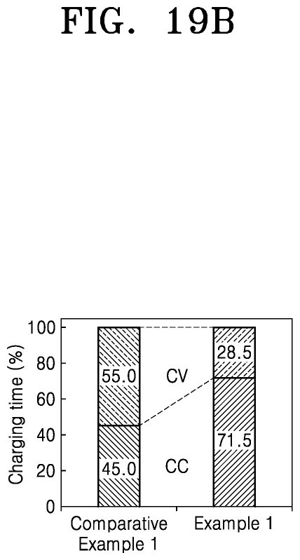

FIG. 19 shows a charging profile in the 280^{th} charging cycle. As shown in FIG. 19, in the lithium battery of Example 1, a constant current charging occurred during 70% or more of the charging time, and a voltage increase due to a side reaction was suppressed.

In contrast, In the lithium battery of Comparative Example 1, constant current reaction time was reduced to 45%, and thus a side reaction was increased, so that a limit voltage was reached early.

According to an aspect, a cathode has improved electronic conductivity, a contact area between the cathode and an electrolyte increases, and a local side reaction between the cathode and the electrolyte is suppressed.

According to another aspect, the reversibility, high-rate characteristics and lifespan characteristics of an electrochemical battery are improved.

It should be understood that embodiments described herein should be considered in a descriptive sense only and not for purposes of limitation. Descriptions of features or aspects within each embodiment should be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A cathode comprising:
a cathode current collector;
a cathode active material layer on the cathode current collector and comprising
a first surface, and
a second surface opposite the first surface and adjacent to the cathode current collector,
wherein the cathode active material layer comprises a channel structure comprising a channel extending in a direction from the first surface to the second surface; and
a conductive metal layer disposed on a surface of the channel of the channel structure.

2. The cathode of claim 1, wherein the conductive metal layer has a thickness of about 1 nanometer to about 50 nanometers.

3. The cathode of claim 1,
wherein the conductive metal layer is on the first surface of the cathode active material layer and on a surface of the channel that extends from the first surface to the second surface of the cathode active material layer.

4. The cathode of claim 1,
wherein an area of the conductive metal layer on the first surface of the cathode active material layer is about 1 percent to about 99 percent, based on a total area of the cathode active material layer.

5. The cathode of claim 3,
wherein a ratio of a thickness of the conductive metal layer on the surface of the channels to a thickness of the conductive metal layer on the first surface of the cathode active material layer is about 0.3 to about 1.5.

6. The cathode of claim 1,
wherein the conductive metal layer comprises ruthenium, aluminum, gold, platinum, nickel, indium, copper, magnesium, stainless steel, titanium, iron, zinc, germanium, an alloy thereof, or a combination thereof.

7. The cathode of claim 1, wherein the channel structure comprises a through-hole extending from the first surface to the second surface of the cathode active material layer.

8. The cathode of claim 1,
wherein the channel comprises one or more channels, and a total cross-sectional area of the one or more channels is about 1 percent to about 15 percent, based on a total area of the first surface of the cathode active material layer, and
wherein a diameter of each of the one or more channels is about 10 micrometers to about 300 micrometers.

9. The cathode of claim 1, further comprising a metal oxide layer on the conductive metal layer.

10. The cathode of claim 9,
wherein an area of the metal oxide layer on the first surface of the cathode active material layer is about 1 percent to about 100 percent, based on a total area of the conductive metal layer on the first surface of the cathode active material layer.

11. The cathode of claim 9,
wherein the metal oxide layer comprises an oxide of a metal of ruthenium, aluminum, gold, platinum, nickel, indium, copper, magnesium, stainless steel, titanium, iron, zinc, germanium, an alloy thereof, or a combination thereof.

12. The cathode of claim 1, further comprising a deposition layer on the conductive metal layer, wherein the deposition layer is ion conductive.

13. The cathode of claim 1,
wherein the cathode active material layer has a density of about 4.0 grams per cubic centimeter to about 4.9 grams per cubic centimeter.

14. The cathode of claim 1,
wherein the cathode active material layer comprises a cathode active material layer structure,
wherein the cathode active material layer structure comprises
a first cathode active material layer and a second cathode active material layer, wherein the second cathode active material layer is disposed on the first cathode active material layer and extends in the direction from the first surface to the second surface,
wherein the first cathode active material layer comprises a first through-hole extending in the direction from the first surface to the second surface, and
the second cathode active material layer comprises a second through-hole extending in the direction from the first surface to the second surface.

15. The cathode of claim 14,
wherein the first through-hole and the second through-hole are aligned in a first direction.

16. The cathode of claim 14,
wherein the first cathode active material layer has a first porosity, the second cathode active material has a second porosity, and the first porosity is greater than the second porosity.

17. The cathode of claim 14,
wherein each of the first cathode active material layer and the second cathode active material layer is a binder-free layer.

18. An electrochemical battery comprising:
the cathode of claim 1;
an anode;
a separator between the cathode and the anode; and
a liquid electrolyte in a pore of the separator.

19. A method of manufacturing a cathode, the method comprising:
providing a cathode active material layer comprising a first surface and a second surface opposite the first surface and comprising a channel structure extending in a direction from the first surface to the second surface; and
disposing a conductive metal layer on a surface of a channel of the channel structure to manufacture the cathode.

20. The method of claim 19,
wherein the disposing of the conductive metal layer comprises atomic layer deposition.
